(19) United States
(12) Patent Application Publication
(10) Pub. No.: US 2017/0315975 A1
(43) Pub. Date: Nov. 2, 2017

(54) ANNOTATIONS FOR DIGITAL MEDIA ITEMS DURING CAPTURE

(71) Applicant: SEAGATE TECHNOLOGY LLC, Cupertino, CA (US)

(72) Inventors: Kevin Arnold, Cupertino, CA (US); Jeff Ma, Cupertino, CA (US)

(21) Appl. No.: 15/143,271

(22) Filed: Apr. 29, 2016

(51) Int. Cl. G06F 17/24; G06F 3/0488; G06F 3/0482; G06F 3/0484; G10L 15/26; G06F 3/16

(52) U.S. Cl. CPC G06F 17/241; G10L 15/26; G06F 3/165; G06F 3/0482; G06F 3/04842; G06F 3/04883

(57) ABSTRACT

Systems and methods related to audio annotations for a media item. A method includes receiving an input to enter a content capture mode. The method further includes initiating capture of an audio annotation in response to entering the content capture mode. The method also includes acquiring a first media item. The method includes stopping capture of the audio annotation in response to capturing the first media item. The method further includes associating the audio annotation with the first media item. The method also includes outputting the first media item and the audio annotation.

### FIELD

This disclosure relates generally to annotations for digital media items.

### BACKGROUND

Digital photographs are increasingly ubiquitous and created by any number of cameras. The cameras may be integrated in multi-purpose devices such as tablet computers and mobile phones or may be standalone devices whose primary purpose is the creation of digital photographs. Often, people may take pictures and may look at the pictures later or share those pictures with others.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

Embodiments of the invention include a system and method for associating annotations to a digital media item.

In one aspect, a method includes presenting a media item on a display. The method further includes receiving an audio annotation. The method also includes associating the audio annotation with the media item. The method includes outputting the audio annotation and the media item.

In one aspect, a method includes presenting a media item file on an electronic display. The method further includes receiving an audio annotation that includes at least one audible word in an electronic audio format. The method also includes converting the audible word to a text-based word. The method further includes tagging the media item with the text-based word. The method further includes outputting the media item with the text-based word.

In one aspect, a mobile device includes an image sensor, a memory, and a processor operatively coupled to the memory. The processor is configured to receive, via a graphical user interface, input to enter a content capture mode. The processor is also configured to initiate capture of an audio annotation in response to entering the content capture mode. The processor is configured to capture a first image via the image sensor. The processor is further configured to stop capture of the audio annotation in response to capturing the first image. The processor is also configured to associate the audio annotation with the first image in an electronic file. The processor is configured to output the electronic file with the first image and the audio annotation.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates an example block diagram of a system that may be used to create annotations for a media item according to some embodiments.

FIG. 2 illustrates an example flowchart of a method to create annotations for a media item according to some embodiments.

FIG. 3 illustrates an example flow diagram of a method to generate an annotation to tag a media item according to some embodiments.

FIG. 4 illustrates an example flowchart of a method to create annotations for a media item during a content capture mode according to some embodiments.

FIG. 5 illustrates an example flowchart of a method to create annotations for a media item in an application according to some embodiments.

FIG. 6 illustrates an example flowchart of a gesture-based method to create annotations for a media item according to some embodiments.

FIG. 7 illustrates an example flowchart of a method to create annotations for multiple media items according to some embodiments.

FIG. 8 shows an illustrative computing device for performing functionality to facilitate implementation of embodiments.

### DETAILED DESCRIPTION

Digital photographs are increasingly ubiquitous and created by any number of cameras. The cameras may be integrated in multi-purpose devices such as tablet computers and mobile phones or may be standalone devices whose primary purpose is the creation of digital photographs. Often, people may take pictures and may look at the pictures later or share those pictures with others. Some users may manually type annotations or tags for the picture to simplify later retrieval of those pictures.

According to at least one embodiment described in the present disclosure, systems and methods may be configured to create annotations for a media item (e.g., picture) based on audio received at a client device. The annotations for the media item may include tags and/or metadata. The annotations may also be audio-based or video-based and may playback when the media item is presented on a display. The tags may be searchable, such as locally or via a cloud. Aspects of the disclosure may be beneficial by providing a user-friendly mechanism to quickly and efficiently receive an annotation and associate the annotation with a media item. Some aspects may also be directed to preserving an association between a media item that is stored separately from an annotation in the event that the media item or annotation are moved to another file location. The disclosed system may generate an identifier for the annotation and associate the identifier with the media item. The identifier may include a link to the annotation that may be updated if the media item and/or annotation are moved to another location. Some aspects are directed to playing back a media item with the annotations. For post capture annotations, some aspects of the disclosure may receive a gesture to initiate and/or stop an annotation capture process.

The term “media item” may include may include one or more images, photographs, text-based electronic document, movie clips, TV clips, music videos, or any other multimedia content or electronic document. By way of example and for simplicity in explanation, an image, which is an example of one type of media item, may be referred to herein with the understanding that any media item may be used and/or annotated according to the present disclosure.

An example method includes receiving, via a graphical user interface, an input to enter a content capture mode. The method further includes initiating capture of an audio annotation in response to entering the content capture mode. The method also includes capturing a first media item, such as via an image sensor. The method includes stopping capture of the audio annotation in response to capturing the first media item. The method further includes associating the audio annotation with the first media item in an electronic file in response to stopping capture of the audio annotation. The method also includes outputting the electronic file with the first media item and the audio annotation.

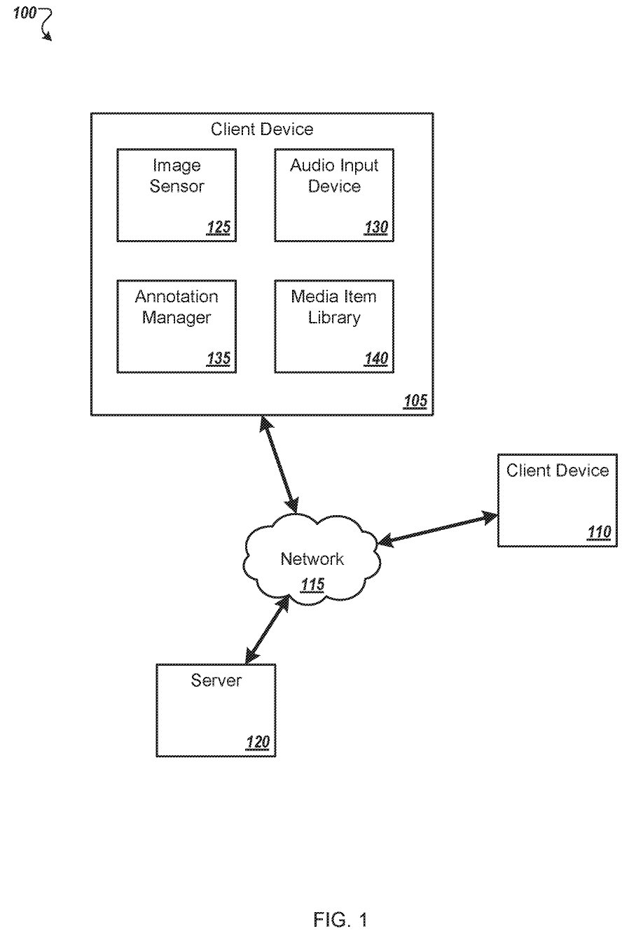

FIG. 1 illustrates an example block diagram of a system 100 that may be used to create annotations for a media item according to some embodiments. The system 100 may include one or more client devices 105, 110, a network 115 and a server 120.

The client device 105 may be a portable computing device, such as, and not limited to, a cellular telephone, a personal digital assistant (PDA), a portable media player, a netbook, a laptop computer, an electronic book reader, a tablet computer, and the like. The client device 105 may run an operating system (OS) that manages hardware and software of the client device 105. The client device 105, the OS and modules within the OS can perform various operations, such as facilitating creation of an annotation for a media item. The client device 110 may include some or all of the features of the client device 105.

The network 115 may include one or more wide area networks (WANs) and/or local area networks (LANs) that enable the client device 105, the client device 110 and/or the server 120 to communicate with each other. In some embodiments, the network 115 includes the Internet, including a global internetwork formed by logical and physical connections between multiple WANs and/or LANs. Alternately or additionally, the network 115 may include one or more cellular RF networks and/or one or more wired and/or wireless networks such as, but not limited to, 802.xx networks, Bluetooth access points, wireless access points, IP-based networks, or the like. The network 115 may also include servers that enable one type of network to interface with another type of network.

The server 120 may include one or more computing devices, (such as a rackmount server, a router computer, a server computer, a personal computer, a mainframe computer, a laptop computer, a web server, a proxy server, a desktop computer, etc.), data stores (e.g., hard disks, memories, databases), networks, software components, and/or hardware components. The server 120 may perform some or all of the operations described herein.

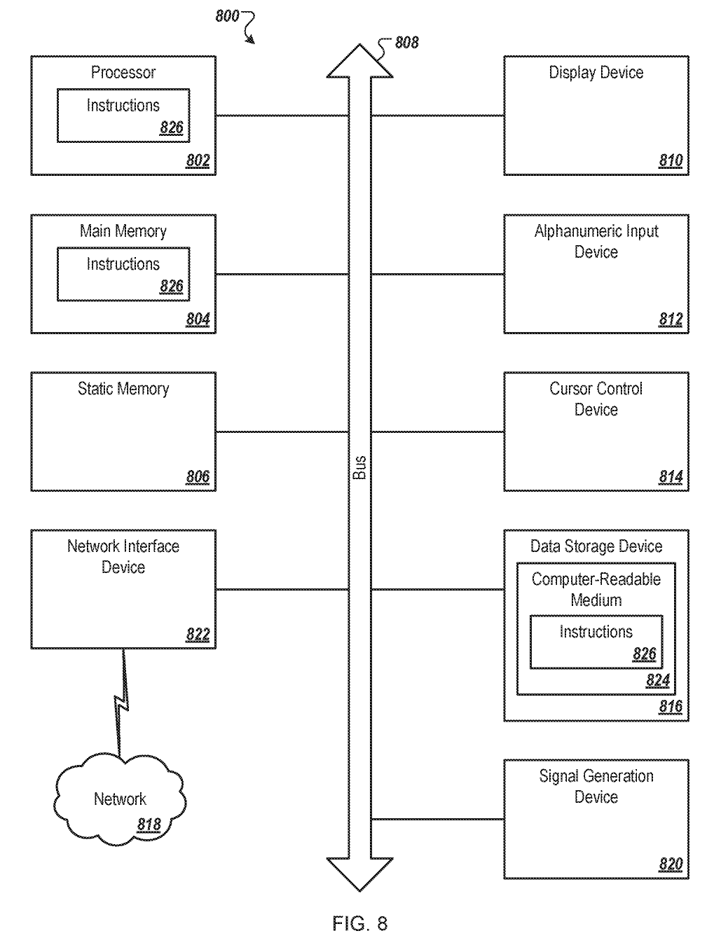

The client device 105 may include an image sensor 125, an audio input device 130, an annotation manager 135 and a media item library 140. The annotation manager 135 may include any type of controller, processor or logic. For example, the annotation manager 135 may include all or any of the components of computing device 800 shown in FIG. 8.

The image sensor 125 may include any camera that captures images of any aspect ratio, size, and/or frame rate. The image sensor 125 may sample and record a field of view. The image sensor, for example, may include a CCD or a CMOS sensor. For example, the aspect ratio of the image produced by the image sensor 125 may be 1:1, 4:3, 5:4, 3:2, 16:9, 10:7, 9:5, 9:4, 17:6, etc., or any other aspect ratio. As another example, the size of the camera's image sensor may be 9 megapixels, 15 megapixels, 20 megapixels, 50 megapixels, 100 megapixels, 200 megapixels, 500 megapixels, 1000 megapixels, etc., or any other size. The image sensor 125 may provide raw or compressed image data. Image data may be saved directly or indirectly to a memory (not illustrated). Images captured by the image sensor 125 may be stored in the media item library 140. The image sensor 125 may also capture video that may be used as a video annotation.

The audio input device 130 may include one or more microphones for collecting audio. The audio may be recorded as mono, stereo, surround sound (any number of tracks), Dolby™, etc., or any other audio format. Moreover, the audio may be compressed, encoded, filtered, compressed, etc. The audio data may be saved directly or indirectly into a memory (not illustrated). The audio data may also, for example, include any number of tracks. For example, for stereo audio, two tracks may be used. And, for example, surround sound 5.1 audio may include six tracks.

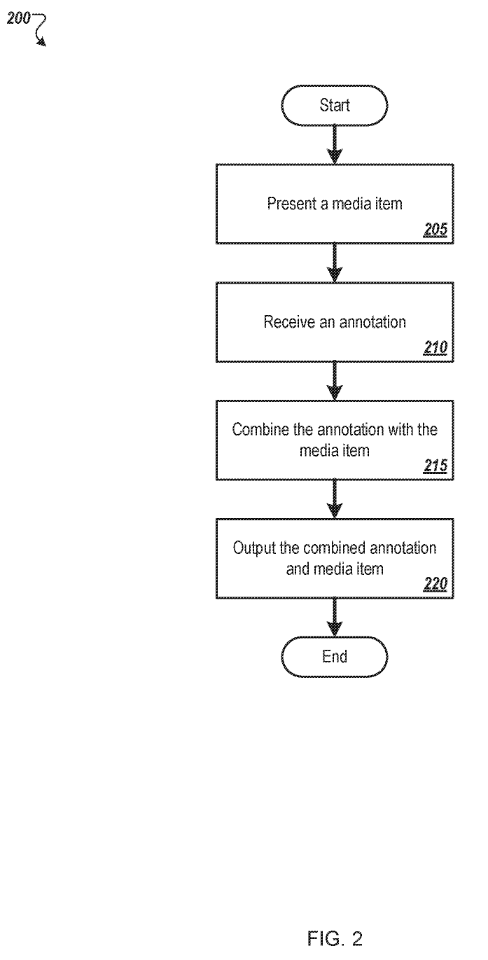

The annotation manager 135 may be communicatively coupled with the image sensor 125 and the audio input device 130 and/or may control the operation of the image sensor 125 and the audio input device 130. The annotation manager 135 may also be used to receive and associate or combine audio data, video data, and media item data, such as by associating audio annotations or video annotations with a media item. The annotation manager 135 may also perform various types of processing, filtering, compression, etc. of media item data and/or audio data prior to storing the media item data and/or audio data into a memory (not illustrated). The annotation manager 135 may create annotations for one or more media items and/or tag media items with annotations, using various techniques, as described further in conjunction with FIGS. 2-7.

The media item library 140 may be any type of data store for storing media item. For example, the data store may be a memory (e.g., random access memory), a cache, a drive (e.g., a hard drive), a flash drive, a database system, or another type of component or device capable of storing data. The data store may also include multiple storage components (e.g., multiple drives or multiple databases) that may also span multiple computing devices (e.g., multiple server computers).

In operation, to generate one or more annotations for a media item, the client device 105 may present the media item on an electronic display. The client device 105 may receive an audio annotation or a video annotation. The client device 105 may associate the annotation with the media item. The client device 105 may output the annotation and the media item. For ease in explanation, various embodiments are described with respect to generating an audio annotation with the understanding that video annotations may be handled in a similar manner as audio annotations.

In at least one embodiment, the client device 105 may receive an audio annotation that includes at least one audible word in an electronic audio format. The client device 105 may convert the audible word to a text-based word. The client device 105 may tag the media item with the text-based word. The client device 105 may output the media item with the text-based word. The text-based word may be searchable via any device, such as via the client device 105 and/or the server 120.

In at least one embodiment, the client device 105 may receive, via a graphical user interface, input to enter a content capture mode. The content capture mode may include a discrete application on the client device 105 or a mode within an application on the client device 105. The graphical user interface may include a visual cue for the content capture mode. For example, the graphical user interface may include one or more icons (e.g., a microphone) that may indicate to the user of the availability of the content capture mode. The client device 105 may initiate capture of an audio annotation in response to entering the content capture mode. In at least one embodiment, the graphical user interface may include visual feedback during the time that the audio annotation is captured. For example, the graphical user interface may include a waveform while the audio annotation is being recorded.

The client device 105 may capture or acquire a first media item, such as via the image sensor 125. The client device 105 may stop capture of the audio annotation in response to capturing the first media item. The client device 105 may associate the audio annotation with the first media item in an electronic file. The client device 105 may output the electronic file with the first media item and the audio annotation. In at least one embodiment, outputting the electronic file with the first media item and the audio annotation may include sending the electronic file with the first media item and the audio annotation to the server 120 or to the client device 110. In at least one embodiment, outputting the electronic file with the first media item and the audio annotation may include saving the electronic file with the first media item and the audio annotation to the media item library 140 or presenting the first media item on a display while playing the audio annotation.

Further details of annotation generation for a media item are described below.

FIGS. 2-7 are flow diagrams of various methods related to generating an audio annotation or a video annotation for a media item. The methods may be performed by processing logic that may include hardware (circuitry, dedicated logic, etc.), software (such as is run on a general purpose computer system or a dedicated machine), or a combination of both, which processing logic may be included in the client device 105 or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. The methods illustrated and described in conjunction with FIGS. 2-7 may be performed, for example, by a system such as the system 100 or annotation manager 135 of FIG. 1. However, another system, or combination of systems, may be used to perform the methods. Although illustrated as discrete blocks, various blocks may be divided into additional blocks, combined into fewer blocks, or eliminated, depending on the desired implementation.

FIG. 2 illustrates an example flowchart of a method 200 to create annotations for a media item according to some embodiments. The method 200 may begin at block 205, where the processing logic may present a media item (e.g., an image) on a display. The media item may have been previously captured by a camera. In at least one embodiment, the media item on the display is a live preview of a subject to be captured. For example, in response to the processing logic receiving an input to take a picture, the processing logic may cause a camera to capture an image or video based on what was being presented on the display at the time the input was received. The image may be presented in response to user selection of the image.

At block 210, the processing logic may receive an audio annotation. The audio annotation may be received via a microphone. Alternatively, the audio annotation may have been previously recorded. The audio annotation may be any type of audio, such as audible words or sound effects from a user. For example, a user may speak into a microphone. The sounds and/or words captured by the microphone may be the audio annotation. In at least one embodiment, the processing logic may receive the audio annotation while the media item is playing. The processing logic may identify of generate an identifier of the audio annotation. For example, the processing logic may generate a random, or semi-random string of characters as the identifier of the audio annotation. The processing logic may store the audio annotation in a data storage. The identifier may also include a link or location of the audio annotation in the date storage.

At block 215, the processing logic may combine or associate the audio annotation with the media item. To associate the audio annotation with the media item, for example, the processing logic may associate both the audio annotation and the media item with an electronic file. In at least one embodiment, the electronic file is a media item file (e.g., jpeg, png, gif). In at least one embodiment, the electronic file is a file format for audio and images (e.g., mpeg, fly, avi, mov, mp4). In at least one embodiment, the audio annotation and the media item file may be in their respective native file formats and the processing logic may create a new electronic file that packages or associates the audio annotation and the media item file. In at least one embodiment, the processing logic may associate the identifier of the audio annotation with the media item. For example, the processing logic may include the identifier of the audio annotation in metadata of the media item.

At block 220, the processing logic may output the audio annotation and the media item. In at least one embodiment, outputting the audio annotation and the media item may include presenting the media item on the display while playing the audio annotation on a speaker. In at least one embodiment, outputting the audio annotation and the media item may include sending the audio annotation and the media item to a server or a client device. In at least one embodiment, outputting the audio annotation and the media item may include outputting the media item with the associated identifier of the audio annotation and/or the audio annotation. In at least one embodiment, the audio annotation may be moved to another location or address in the data storage (or moved to another date storage). The processing logic may use the same identifier or generate a new identifier for the audio annotation. The processing logic may also update the metadata of the media item to identifier any changes to the identifier. When playing back the media item with the audio annotation, the identifier may be used to identify the audio annotation. The audio annotation also may be retrieved from a data storage based on the identifier of the audio annotation.

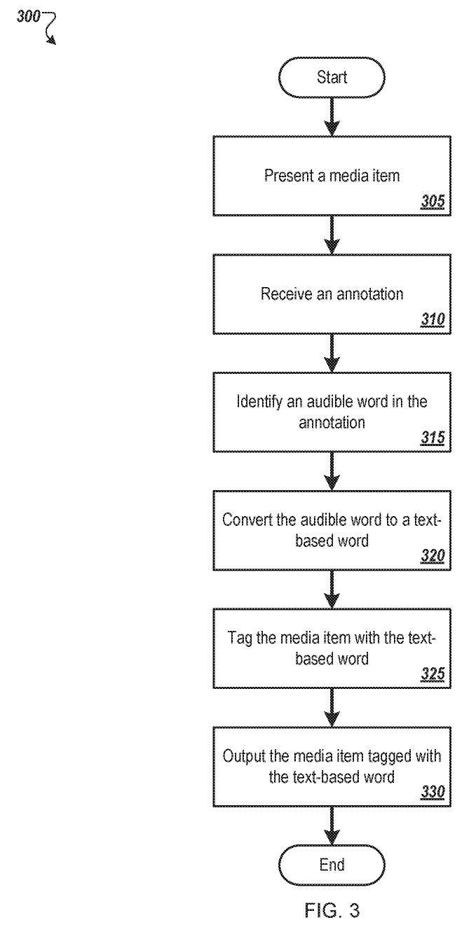

FIG. 3 illustrates an example flow diagram of a method 300 to generate an annotation to tag a media item according to some embodiments. The method 300 may begin at block 305, where the processing logic may present a media item on an electronic display, as described in conjunction with FIG. 2. At block 310, the processing logic may receive an audio annotation that includes at least one audible word in an electronic audio format. In at least one embodiment, the audio annotation may be audible words and the processing logic may receive the audible words via a microphone.

At block 315, the processing logic may identify an audible word in the audio annotation. To identify an audible word in the audio annotation, the processing logic may digitally analyze the audio annotation against a set of known sounds that are associated with words. The processing logic may identify any number of audible words in the audio annotation. At block 320, the processing logic may convert the audible word to a text-based word. In at least one embodiment, the processing logic may use speech-to-text detection and processing techniques to convert the audible word to a text-based word.

At block 325, the processing logic may tag the media item with the text-based word. In at least one embodiment, the processing logic may associate the text-based word with metadata of the media item. At block 330, the processing logic may output the media item with the text-based word. In at least one embodiment, the processing logic sends a message or an email that includes the media item and the text-based word in the body and/or subject of the message or email.

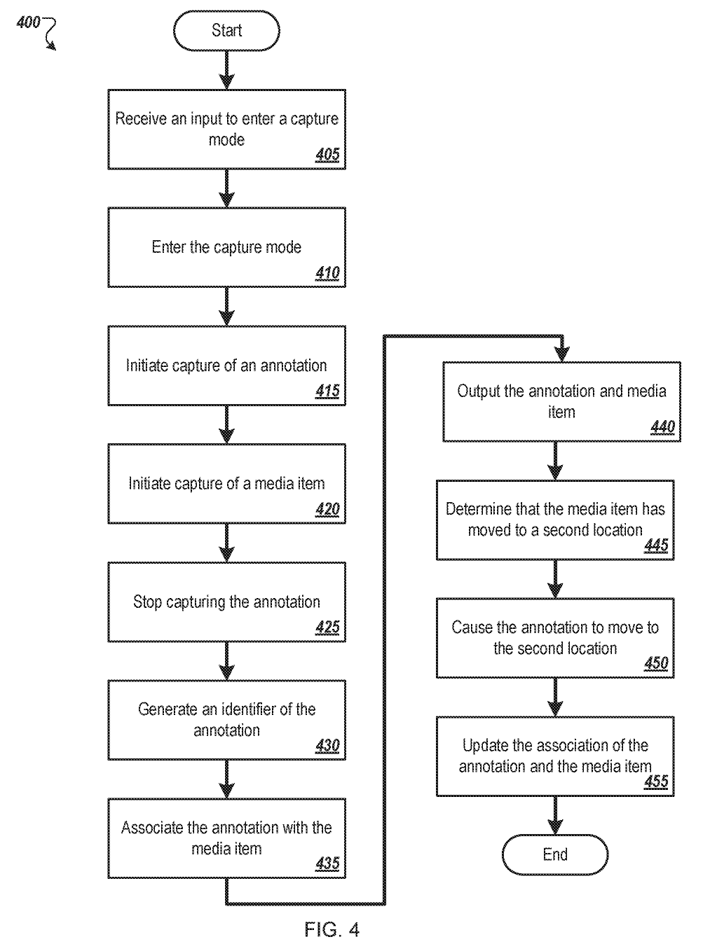

FIG. 4 illustrates an example flowchart of a method 400 to create annotations for a media item during a content capture mode according to some embodiments. The method 400 may begin at block 405, where the processing logic may receive an input to enter a content capture mode. In at least one embodiment, an audio annotation is received during the content capture mode. In at least one embodiment, the media item is captured during the content capture mode. In at least one embodiment, the input includes a request to capture the media item using an image sensor associated with a client device. In at least one embodiment, the input may include a request to capture the media item using an image sensor associated with a client device. For example, the processing logic may receive the input, via a graphical user interface, from a user to take a picture. At block 410, the processing logic may enter the capture mode in response to receiving the input to enter the content capture mode.

At block 415, the processing logic may initiate capture of the audio annotation. In at least one embodiment, the processing logic may initiate capture of the audio annotation in response to receiving the request to capture the media item. In at least one embodiment, the processing logic may initiate capture of the audio annotation prior to capturing the media item. The processing logic may implement a time-delay after initiating capture of the audio annotation before capturing the media item. In some embodiments, the processing logic may initiate capture of the audio annotation when a media item capture application is opened and/or when the client device is positioned and/or oriented to take a photograph. The processing logic may capture audio continuously, but, in some examples, it may only keep a portion of the audio captured prior to and just after capturing a media item. At block 415, the processing logic may initiate capture of the media item.

At block 425, the processing logic may stop capturing the audio annotation. In at least one embodiment, the processing logic may stop capturing the audio annotation at any time after capturing the media item. For example, the processing logic may capture the audio annotation for a period of time after capturing the media item. The period of time may be any duration, such as 1 second, 5 seconds, 10 seconds, etc. In at least one embodiment, the period of time is defined and configurable by a user.

At block 430, the processing logic may generate an identifier of the annotation. The identifier of the annotation may identify a location of a file associated with the annotation. For example, the annotation may be stored in or as a file, and the identifier may indicate a location where the file may be stored.

At block 435, the processing logic may associate the audio annotation and the media item, as described in conjunction with FIG. 2. In at least one embodiment, the processing logic may trim a portion of the audio annotation that was captured before or after the capture of the media item. For example, when five seconds of audio is initially captured prior to capturing the media item at block 420, the processing logic may trim three seconds off of the five seconds. In another example, when the audio annotation is captured for a period of time after capturing the media item, the processing logic may trim the audio annotation. For example, when the processing logic captures 60 seconds of audio after capturing the media item, the processing logic may trim the audio annotation to any shortened length. As in this example, the processing logic may trim the audio annotation to 5 seconds, 15 seconds or 30 seconds. In at least one embodiment, the length of the trimmed audio annotation that was captured after the media item may be any length and may be defined and configurable by a user. At block 440, the processing logic may output the audio annotation and the media item, as described in conjunction with FIG. 2. In at least one embodiment, associating the identifier of the audio annotation with the media item may include storing the identifier of the audio annotation as metadata of the media item or a file associated with the media item.

At block 445, the processing logic may determine that the media item has moved to a second location. The media item may have been moved for any reason and by any actor, such as by a user seeking to organize his files. In at least one embodiment, the processing logic may receive a notification or message that the media item has been moved. For example, a daemon my monitor annotated files and may generate a message after detecting that an annotated file has been moved. The daemon may send the message to the processing logic. In at least one embodiment, the daemon may be included in the processing logic.

At block 450, the processing logic may cause the annotation to move from a first location to a second location. For example, the processing logic may move the annotation to a location where the media item is located.

At block 455, the processing logic may update the association of the annotation and the media item. For example, the processing logic may update the identifier of the annotation in the metadata of the media item to indicate a location of the annotation (e.g., the second location).

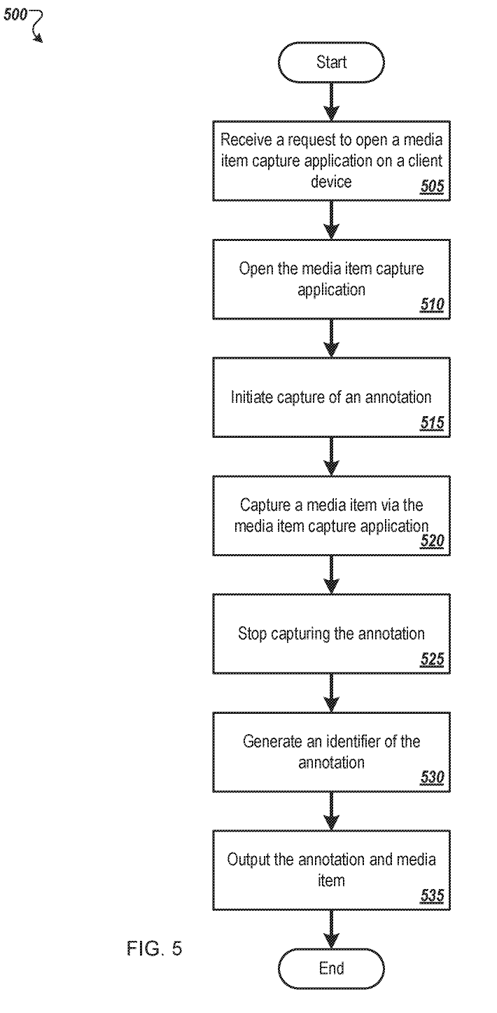

FIG. 5 illustrates an example flowchart of a method 500 to create annotations for a media item in an application according to some embodiments. The method 500 may begin at block 505, where the processing logic may receive a request to open a media item capture application on a client device. In at least one embodiment, opening the media item capture application may include entering a content capture mode, as further described in conjunction with FIG. 4.

At block 510, the processing logic may open the media item capture application on the client device in response to receiving the request. At block 515, the processing logic may initiate capture of an audio annotation in response to opening the media item capture application.

At block 520, the processing logic may capture or acquire the media item, such as by using an image sensor. In at least one embodiment, the processing logic may delay capturing the media item after a predetermined amount of time since initiating the capture of the audio annotation at block 510. In at least one embodiment, the processing device may capture the media item using the image sensor while continuing to capture the audio annotation.

At block 525, the processing logic may stop capturing the audio annotation. In at least one embodiment, the processing logic may stop capturing the audio annotation in response to capturing the media item. In at least one embodiment, the processing device may stop capturing the audio annotation after a predetermined amount of time has lapsed since capturing the media item.

At block 530, the processing logic may associate the audio annotation and the media item, as described in conjunction with FIG. 2. At block 535, the processing logic may output the audio annotation and the media item, as described in conjunction with FIG. 2.

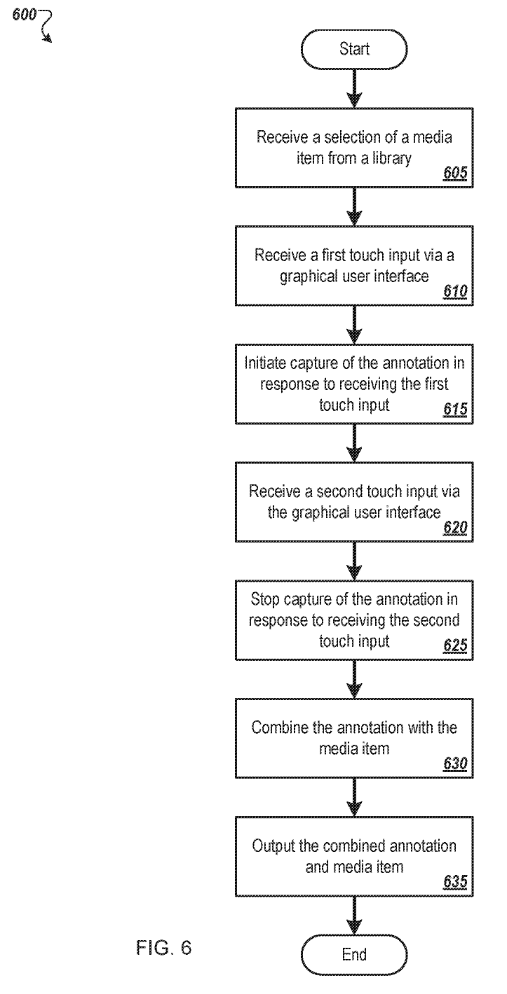

FIG. 6 illustrates an example flowchart of a gesture-based method 600 to create annotations for a media item according to some embodiments. The method 600 may begin at block 605, where the processing logic may receive a selection of a media item from a media item library. In at least one embodiment, the processing logic may receive the selection via a graphical user interface. The media item library may be a collection of images, such as images stored on a client device, on a server, or a combination thereof. The processing logic may present a representation of the media item via an electronic display.

At block 610, the processing logic may receive a first touch input via a graphical user interface. The touch input may be any type of touch or gesture on a touch-activated device (e.g., a capacitive sensor array, touch screen). The touch or gesture may include a tap, a swipe, a pinch, an expand, pull-down, a press-and-hold, and the like. For example, while the media item is being presented in a display, a user may tap the display, which may be the first touch. In at least one embodiment, in response to receiving the touch or gesture, the processing logic may present a menu in a graphical user interface that includes one or more options pertaining to annotating a media item.

At block 615, the processing logic may initiate capture of the audio annotation in response to receiving the first touch input. For example, upon receiving the tap on the display from the user, the processing logic may initiate audio capture from a microphone and/or video capture from an image sensor. In at least one embodiment, the audio annotation is received while at least a portion of the media item is being presented on a client device.

At block 620, the processing logic may receive a second touch input via the graphical user interface. The second touch input may the same or different type of touch or gesture as the first touch input. At block 625, the processing logic may stop capture of the audio annotation in response to receiving the second touch input. In an example, a user may use their finger to touch or pull-down on the display device, speak words into the microphone and then release their finger the display device to stop recording. The spoken words may or may not be related to the content presented in the media item.

At block 630, the processing logic may associate the audio annotation (or an identifier of the audio annotation) and the media item, as described in conjunction with FIG. 2. At block 635, the processing logic may output the audio annotation and the media item, as described in conjunction with FIG. 2.

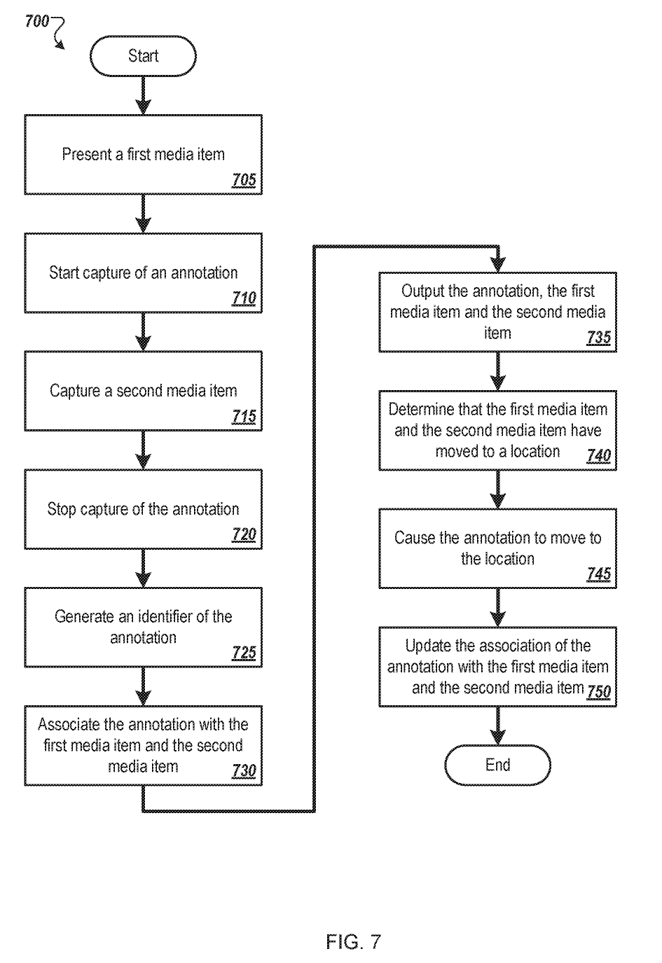

FIG. 7 illustrates an example flowchart of a method 700 to create annotations for multiple media items according to some embodiments. The method 700 may begin at block 705, where the processing logic may present a first media item, as further described in conjunction with FIG. 2. At block 710, the processing logic may start capture of an audio annotation, as described herein.

At block 715, the processing logic may capture or acquire a second media item, such as via an image sensor. In at least one embodiment, the processing logic may capture the second media item while continuing to capture the audio annotation. At block 720, the processing logic may stop capturing the audio annotation. In at least one embodiment, the processing logic may stop capturing the audio annotation at the same time or any time after capturing second media item.

At block 725, the processing logic may generate an identifier of the annotation. The identifier of the annotation may identify a location of a file associated with the annotation. For example, the annotation may be stored in or as a file, and the identifier may indicate a location where the file may be stored.

At block 730, the processing logic may associate the audio annotation, the first media item and the second media item, as similarly described in conjunction with FIG. 2. In at least one embodiment, when associating the audio annotation and the media item, the processing device may associate the audio annotation with the second media item in an electronic file.

At block 735, the processing logic may output the audio annotation, first media item and second media item, as similarly described in conjunction with FIG. 2. In at least one embodiment, when outputting the electronic file with the first media item, second media item, and the audio annotation, the processing logic may output the electronic file with the first media item, the second media item, and the audio annotation. In at least one embodiment, when outputting the electronic file with the first media item, the second media item, and the audio annotation, the processing logic may play the audio annotation, such as via a speaker. The processing logic may present the first media item via the graphical user interface while continuing to play the audio annotation and present the second media item via the graphical user interface while continuing to play the audio annotation.

At block 740, the processing logic may determine that the first media item and the second media item have moved to a location. The first media item and the second media item may have been moved for any reason and by any actor, such as by a user seeking to organize his files. In at least one embodiment, the processing logic may receive a notification or message that the first media item and the second media item have been moved. For example, a daemon my monitor annotated files and may generate a message after detecting that an annotated file has been moved. The daemon may send the message to the processing logic. In at least one embodiment, the daemon may be included in the processing logic.

At block 745, the processing logic may cause the annotation to move from a first location to a second location. For example, the processing logic may move the annotation to a location where the media item is located.

At block 750, the processing logic may update the association of the annotation with the first media item and the second media item. For example, the processing logic may update the identifier of the annotation in the metadata of the first media item and the second media item to indicate a location of the annotation (e.g., the second location).

FIG. 8 illustrates a diagrammatic representation of a machine in the example form of a computing device 800 within which a set of instructions, for causing the machine to perform any one or more of the methodologies discussed herein, may be executed. The computing device 800 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methodologies discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In one implementation, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 (e.g., system 106) embodying any one or more of the methodologies or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 826 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methodologies of the present disclosure. The term “computer-readable storage medium” may accordingly be taken to include, but not be limited to, solid-state memories, optical media and magnetic media.

In these or other embodiments, media item files associated with media items may include metadata such as geolocation data, audio data, voice tag data, motion data, biological data, temperature data, a time stamp, a date stamp, user tag data, barometric pressure data, people data, and/or camera orientation data. Some or all of the metadata of the media item files may be used as annotations for the corresponding media item.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it may be understood that the various changes, substitutions, and alterations may be made hereto without departing from the spirit and scope of the present disclosure.

The term “substantially” means within 5% or 10% of the value referred to or within manufacturing tolerances.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for—purposes of example rather than limitation, and does not preclude inclusion of such modifications, variations, and/or additions to the present subject matter as would be readily apparent to one of ordinary skill in the art.

What is claimed is:

1. A method, comprising:
receiving an input to enter a content capture mode;
initiating, by a processing device, capture of an audio annotation in response to entering the content capture mode;
acquiring a first media item after the audio annotation has begun to capture;
stopping capture of the audio annotation after capturing the first media item, wherein the audio annotation is stored in a first location as a first file and the first media item is stored as a second file in the first location;
generating an identifier of the audio annotation, wherein the identifier of the audio annotation identifies a location of the first file;
associating, by the processing device, the identifier of the audio annotation with the first media item in response to stopping capture of the audio annotation, wherein associating the identifier of the audio annotation with the first media item comprises storing the identifier of the audio annotation as metadata of the second file;
outputting the first media item and the identifier of the audio annotation;
determining that the first file has moved from the first location to a second location;
causing the audio annotation to move from the first location to the second location; and
updating the identifier of the audio annotation in the metadata of the second file to indicate the location of the second file as the second location.

2. The method of claim 1, wherein the input comprises a first request to open a media item capture application on a client device, wherein capture of the audio annotation is initiated in response to the media item capture application being opened.

3. The method of claim 1 further comprising capturing a second media item, wherein the capture of the audio annotation is stopped in response to capturing the first media item and the second media item.

4. The method of claim 3 further comprising associating the identifier of the audio annotation with the second media item, and wherein outputting the first media item and the identifier of the audio annotation comprises outputting the first media item, the second media item, and the identifier of the audio annotation.

5. The method of claim 4, wherein outputting the first media item, the second media item, and the identifier of the audio annotation comprises:
retrieving the audio annotation based on the identifier of the audio annotation;
playing the audio annotation;
presenting the first media item via the graphical user interface while continuing to play the audio annotation; and
presenting the second media item while continuing to play the audio annotation.

6. The method of claim 1, wherein the audio annotation includes at least one audible word, the method further comprising converting the audible word to a text-based word, wherein associating the audio annotation with the first media item comprises:
associating the audio annotation with the first media item in an electronic file; and
tagging the first media item with the text-based word, wherein the electronic file is to be output with the text-based word.

7. The method of claim 1 further comprising trimming a portion of the audio annotation that was captured before or after the capture of the first media item.

8. A mobile device comprising:
a memory; and
a processor operatively coupled to the memory, wherein the processor is configured to:
receive an input to enter a content capture mode;
initiate capture of an audio annotation in response to entering the content capture mode;
capture a first media item after the audio annotation has begun to capture;
stop capture of the audio annotation after capturing the first media item, wherein the audio annotation is stored in a first location as a first file and the first media item is stored as a second file in the first location;
generate an identifier of the audio annotation, wherein the identifier of the audio annotation identifies a location of the first file;
associate the identifier of the audio annotation with the first media item in response to stopping capture of the audio annotation, wherein associating the identifier of the audio annotation with the first media item comprises storing the identifier of the audio annotation as metadata of the second file;
output the first media item and the identifier of the audio annotation;
receive a notification that the first file has moved from the first location to a second location;
cause the audio annotation to move from the first location to the second location; and
update the identifier of the audio annotation in the metadata of the second file to indicate the location of the second file as the second location.

9. The mobile device of claim 8, wherein the input comprises a first request to open a media item capture application on a client device, wherein capture of the audio annotation is initiated in response to the media item capture application being opened.

10. The mobile device of claim 8, wherein the processor is further configured to capture a second media item, wherein the capture of the audio annotation is stopped in response to capturing the first media item and the second media item.

11. The mobile device of claim 10, wherein the processor is further configured to associate the identifier of the audio annotation with the second media item, and wherein when outputting the first media item and the identifier of the audio annotation, the processor is configured to output the first media item, the second media item, and the identifier of the audio annotation.

12. The mobile device of claim 11, wherein when outputting the first media item, the second media item, and the identifier of the audio annotation, the processor is configured to:
retrieve the audio annotation based on the identifier of the audio annotation;
play the audio annotation;
present the first media item while continuing to play the audio annotation; and
present the second media item via the graphical user interface while continuing to play the audio annotation.

13. The mobile device of claim 8, wherein the processor is further configured to trim a portion of the audio annotation that was captured before or after the capture of the first media item.

14. The mobile device of claim 8, wherein the first media item comprises at least one of: a still image, a video, or a text-based electronic document.

15. A non-transitory computer readable storage medium having encoded therein programming code executable by a processor to perform operations comprising:
receiving an input to enter a content capture mode;
initiating, by the processor, capture of an audio annotation in response to entering the content capture mode;
acquiring a first media item after the audio annotation has begun to capture;
stopping capture of the audio annotation after capturing the first media item, wherein the audio annotation is stored in a first location as a first file and the first media item is stored as a second file in the first location;
generating an identifier of the audio annotation, wherein the identifier of the audio annotation identifies a location of the first file;
associating, by the processor, the identifier of the audio annotation with the first media item in response to stopping capture of the audio annotation, wherein associating the identifier of the audio annotation with the first media item comprises storing the identifier of the audio annotation as metadata of the second file;
outputting the first media item and the audio annotation;
receiving a notification that the first file has moved from the first location to a second location;
causing the audio annotation to move from the first location to the second location; and
updating the identifier of the audio annotation in the metadata of the second file to indicate the location of the second file as the second location.

16. The non-transitory computer readable storage medium of claim 15, wherein the input comprises a first request to open a media item capture application on a client device, wherein capture of the audio annotation is initiated in response to the media item capture application being opened.

17. The non-transitory computer readable storage medium of claim 15, the operations further comprising capturing a second media item, wherein the capture of the audio annotation is stopped in response to capturing the first media item and the second media item.

18. The non-transitory computer readable storage medium of claim 17, the operations further comprising associating the identifier of the audio annotation with the second media item, and wherein outputting the first media item and the identifier of the audio annotation comprises outputting the first media item, the second media item, and the identifier of the audio annotation.

19. The non-transitory computer readable storage medium of claim 18, wherein outputting the first media item, the second media item, and the identifier of the audio annotation comprises:
retrieving the audio annotation based on the identifier of the audio annotation;
playing the audio annotation;
presenting the first media item via the graphical user interface while continuing to play the audio annotation; and
presenting the second media item while continuing to play the audio annotation.

20. The non-transitory computer readable storage medium of claim 15, the operations further comprising trimming a portion of the audio annotation that was captured before or after the capture of the first media item.
